(19) United States
(12) Patent Application Publication
(10) Pub. No.: US 2005/0125258 A1
(43) Pub. Date: Jun. 9, 2005

(54) Web-hosted healthcare medical information management system

(76) Inventors: Seth A. Yellin, Atlanta, GA (US); Wayne J. Singer, Goose Greek, SC (US)

Correspondence Address: NEEDLE & ROSENBERG, P.C., SUITE 1000, 999 PEACHTREE STREET, ATLANTA, GA, 30309-3915, US

(21) Appl. No.: 11/037,842

(22) Filed: Jan. 18, 2005

Related U.S. Application Data
(63) Continuation of application No. 09/717,906, filed on Nov. 20, 2000.
(60) Provisional application No. 60/189,527, filed on Mar. 15, 2000.

(51) Int. Cl. G06F 17/60

(52) U.S. Cl. 705/3

(57) ABSTRACT

Base units operated by various types of healthcare professionals access a remote database of patient medical information secured against unauthorized access by electronic patient tokens and patient biometrics. The tokens themselves may store information as well, such as patient biographical information and emergency medical information. To safeguard patient privacy, the remote database does not store patient biographical information or other personal information identifying the patients.

### CROSS-REFERENCE TO RELATED APPLICATION

The benefit of the filing date of U.S. Provisional application Ser. No. 60/189,527, filed Mar. 15, 2000, is hereby claimed, and the disclosure of which is incorporated herein in its entirety by this reference.

### BACKGROUND

1. Field of the Invention

This invention relates generally to electronic healthcare record storage and retrieval and, more specifically, to a system and method in which security of the patient's records is controlled primarily by the patient.

2. Description of the Related Art

Patient medical information is primarily maintained in a fragmented, paper-based system. Such information is rarely shared among medical providers due to difficulty in obtaining legible records in a timely fashion. Furthermore, patients often lack detailed knowledge of their own medical history. As a result of these shortcomings, healthcare providers are often practicing medicine with partial information, which creates the possibility for errors. This error factor is multiplied greatly in emergency situations.

Methods exist that address pieces of the medical errors problem but do not provide a total solution. For example, to address prescription errors, there are hand-held or desktop computer devices that avoid the problem of legibility with handwritten prescriptions. There are also systems that capture medical records electronically within a hospital or similar medical facility, but they do not share them securely and seamlessly with other medical professionals outside the facility. There are also data storage systems that are specific to a given population but are not able or allowed to communicate with other such databases due to the proprietary nature of the systems. In addition, systems are known in which a patient carries a medical information card from which insurance information can be electronically read by a healthcare provider using an appropriate magnetic stripe reader or similar device.

More comprehensive systems have been suggested in which patients are issued smart cards. “Smart card” is the common term for a credit card-like device that has an embedded microprocessor or other digital processing logic and a digital memory. The cards have memory in which is stored biographical information about the patient as well as medical information such as blood type, chronic conditions, allergies, immunizations and drug prescriptions. Some such systems have card readers that can communicate with a centralized database in which related information is stored. Using smart cards to transmit prescriptions from a physician to a pharmacist has also been suggested.

There is a need for a system that facilitates access to patient medical information yet allows the patient to maintain primary control over his or her private information. The present invention addresses these problems and deficiencies and others in the manner described below.

### SUMMARY

The present invention relates to a method and system in which a smart card or other electronic token possessed by a patient and a biometric identification of the patient are used in combination to limit access to electronically stored patient information to authorized healthcare professionals. Healthcare professionals to whom access is authorized can include, for example, physicians, dentists, nurses, pharmacists, laboratory personnel and others. Because the patient controls the use of the smart card and biometric identification, the patient effectively controls the authorization.

Patient healthcare information, such as medical diagnoses, treatments, caregiver comments and impressions, test results, diagnostic data and the like, are primarily stored in a secure database system that can be referred to as an electronic vault and is located remotely from the healthcare professional's clinic, office, hospital or other site. Each patient is issued an electronic token, which can be card-like, pendant-like or have any other suitably portable shape or structure. The patient's name and other such biographical information are stored in the memory of the token itself. An identifier, such as a randomly selected number, is also stored in the token memory and is used as an index to the corresponding patient records stored in the database system. To ensure privacy, no biographical information or other personal information revealing the patient's identity is stored in the database system. The patient's insurance information may also be stored in the token memory. Vital medical information, such as the patient's blood type, current medications, allergies to medicines, emergency contacts, and other information that could be needed by emergency medical personnel, may also be stored in the token memory. Information stored in token memory is encrypted to safeguard against unauthorized access and tampering.

At the healthcare professional's site or other place at which the patient receives services, an electronic base unit that can communicate with the database system via a wide-area network such as the Internet verifies the patient's identity by obtaining a biometric from the patient and comparing it to corresponding information stored in the token memory. The biometric is one known to uniquely identify a person and can be, for example, fingerprint(s), voice print, iris or retinal pattern, genetic marker, facial feature, or anything else that can be obtained by electronically sensing and analyzing an element of a person's body. If the patient's identity is verified in this manner, the healthcare professional can use the base unit, which may be connected to the professional's computer system, to access patient records in the database system and information stored in the token. In certain circumstances, such as when no network access is available in emergency situations, it may be expedient or otherwise useful to access information stored in the token memory without accessing information stored in the database system. The base unit can have any suitable structure and can be a stand-alone device or integrated with another device, such as a computer system or a Personal Digital Assistant (PDA). In circumstances in which the healthcare professional is mobile, such as in an ambulance, the base unit can be, for example, a portable device with wireless network access and an integral display.

The system can be used not only by primary caregivers but also by pharmacists, diagnostic technicians, laboratory personnel, and other healthcare professionals who similarly do not require access to the healthcare information stored in the database system. For example, a physician's base unit can store a prescription in the token memory. A pharmacist's base unit can read the memory to obtain the prescription, and when the pharmacist has filled the prescription the base unit can store an indication of that fact in the token memory. When the patient returns to the physician for a follow-up visit, the physician's base unit can read the memory to allow the physician to determine if the prescription was filled and, if so, when.

It is to be understood that both the foregoing general description and the following detailed description are exemplary and explanatory only and are not restrictive of the invention, as claimed.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 illustrates a system in which base units operated by various types of healthcare professionals access a database of patient medical information secured against unauthorized access by patient smart cards and patient fingerprint biometrics;

FIG. 2 is a generalized perspective view of a system in which a base unit is coupled to a desktop computer;

FIG. 3 is a generalized perspective view of a base unit having an integral display, keyboard and wireless network access;

FIG. 4 is a block diagram of a base unit similar to that of FIG. 3; and

FIG. 5 is a flow diagram illustrating a method of operation of the system.

### DETAILED DESCRIPTION

One or more embodiments of the invention are described below in detail. Referring to the drawings, like numbers indicate like elements throughout the views. Although the illustrated embodiments relate to a medical environment, the invention is applicable to other healthcare environments as well, such as dental. The following is intended to illustrate exemplary ways to make and use what is regarded as the invention, the scope of which is to be defined solely by the appended claims.

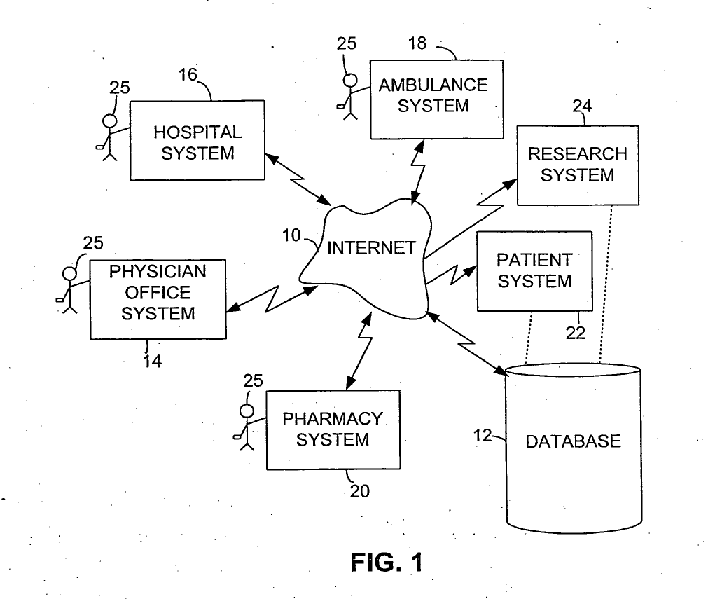

As illustrated in FIG. 1, the Internet 10 provides a medium for data communication between databases 12 and 13 and remote systems 14, 16, 18 and 20 operated by various healthcare professionals and between database 12 and systems 22 and 24. System 14, for example, is located within a physician's office; system 16 is located within a hospital; system 18 is a mobile system located within an ambulance; and system 20 is located within a pharmacy. These locations are merely examples of sites at which the healthcare professionals who staff them can use the present invention, and in other embodiments of the invention similar systems can be located at other sites staffed by other types of healthcare professionals. Note that embodiments of the invention can have systems located at more or fewer types of sites than those illustrated. Along the same lines, embodiments of the invention can have many systems used by each such type of health professional. For example, although only a single physician office system 14 is illustrated for purposes of clarity, an embodiment of the invention can have hundreds or thousands of systems 14 used by hundreds or thousands of physicians throughout the country or the world. As described below in detail, patients 25 interact with these remote systems by allowing their fingerprints to be scanned and presenting smart cards that have been issued to them. Fingerprint information database 13 is used to stored scanned fingerprint information, as described below.

A public key infrastructure (PKI) 23 is interposed between healthcare information database 12 and Internet 10 to enable the enterprise that operates database 12 to provide authentication, access control, confidentiality and non-repudiation for its network applications. Because PKI 23 is well-known in the art, it is not described in detail herein. As persons skilled in the art to which the invention pertains will appreciate, it can perform the above-mentioned functions using advanced technologies such as digital signatures, encryption and digital certificates.

The term “Internet” as used in this patent specification refers to the global super-network or a portion thereof that as of the date of the present invention is commonly known by that name and used to provide connectivity between remotely located computers for commercial, entertainment, educational, research and other purposes. Note that the Internet merely exemplifies a type of wide-area network that can be used in the present invention, and other wide-area networks may be suitable. As well-understood in the art, the Internet is a client-server environment that operates in accordance with various protocols including those known as Internet Protocol (IP) and Transport Control Protocol (TCP). Also note that portions of the Internet may use wires as the physical medium while other portions may use radio communication links. Accordingly, the communication links illustrated in FIG. 1 can be wired (e.g., copper or optical cable) or wireless (e.g., radio). For example, the Internet communication link between ambulance system 18 and database system 12 is at least in part wireless.

Healthcare information database system 12 is a server computer system that can include suitable non-volatile storage media such as magnetic disk arrays, processing units, working memory, database software, operating system software, network communication software, and other hardware and software elements of the types commonly included in server computer systems that manage and provide access to large databases. The database itself can be a relational database. As explained in further detail below, medical information pertaining to patients is stored in database system 12. Database system 12 can be located at any suitable site and can be remote from any or all of systems 14, 16, 18, 20, 22 and 24. Database system 12 can be operated by a third party (i.e., neither a healthcare professional nor a patient), such as contracted by a business entity that enrolls patients in its service program, as described below in further detail.

Patient system 22 and research system 24 can be common personal computers through which medical information can be retrieved from database system 12. (The dashed lines between database system 12 and systems 22 and 24 are intended to indicate that systems 22 and 24 are, as described in further detail below, tied more directly to database system 12 than other remote systems and subject to different database access requirements than other remote systems.) Although not illustrated for purposes of clarity, such computers can access database system 12 via the World Wide Web (“Web”) using conventional Web browser software. As known in the art, a Web browser is a client program that effects the retrieval of hypertext documents (“pages”) from suitably configured Web servers. Web pages can also be forms that a user of the browser can fill in and transmit to a server. Database system 12 includes suitable server software to provide the information requested by patients in Web page format. An introductory or log-in page (not shown) requests the user enter a user name and personal identification number (PIN). If database system 12 determines that the entered user name and PIN are those of authorized users, it provides access to the stored medical information. System 12 permits patients to retrieve and review their own medical records, but not those of others. However, for security purposes, their identities remain screened by a multi-digit alphanumeric sequence. Authorized researchers such as government agencies can likewise be permitted limited access, such as reports derived from aggregate data with no individual's identifiable information, as described in further detail below.

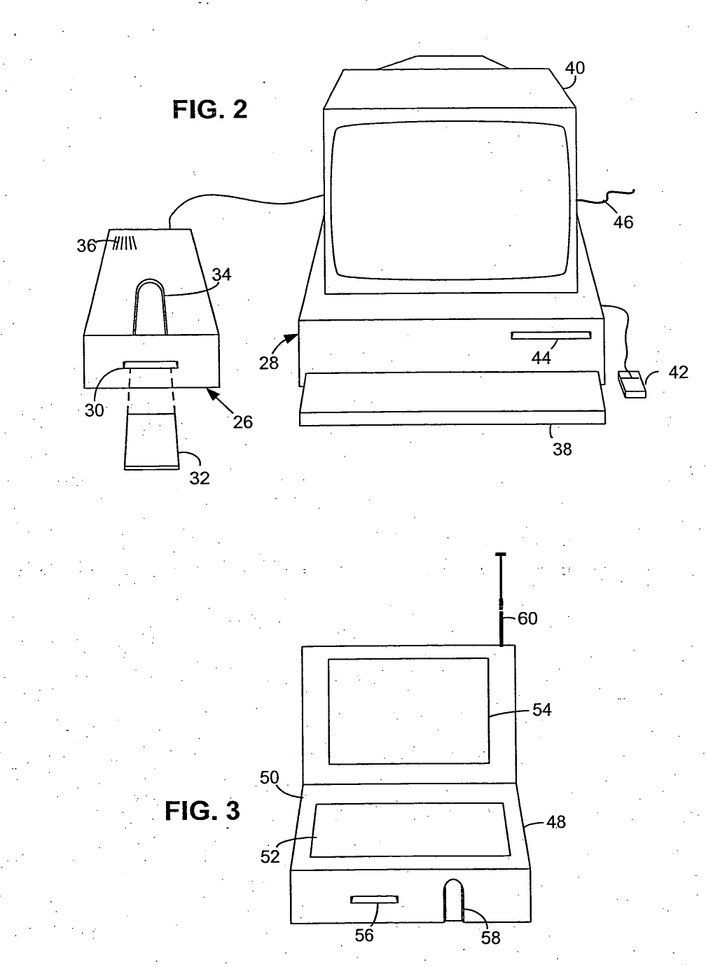

As illustrated in FIG. 2, any or all of the remote systems described above can include a base unit 26 in communication with a computer 28. Nevertheless, in other embodiments of the invention the relevant hardware and software logic and other elements of base unit 26 and computer 28 can be integrated within a single device. In still other embodiments, they can be integrated with other types of portable or non-portable devices.

In the illustrated embodiment of the invention, base unit 26 has a reader/writer unit 30 with a slot into which a smart card 32 can be inserted to read data from and write data to card 32. As well-known in the art to which the present invention relates, a smart card is an electronic device having a card-like housing in which circuitry, including a processor, memory and associated logic (not shown), operate to perform mathematical, data manipulation or other logical operations in accordance with suitable programming. Reader/writer unit 30 interfaces with card 32 via electrical contacts (not shown) on card 32. Nevertheless, in other embodiments of the invention this interface can be any of the equally well-known magnetic, contactless, inductive, radio frequency or other wireless types. The structures and operation of smart card 32 and reader/writer unit 30 are well-understood by persons skilled in the art and are therefore not described in detail in this patent specification. Although smart “cards” are contemplated, the shape of the device is of little relevance to the invention; pendant-like devices as well as pager-like and computer-like wireless devices are known that can perform similar functions. The token could likewise be included in a wristwatch or similar jewelry-like device. Therefore, not only smart cards but any other suitable electronic token can be included. In embodiments of the invention having wireless interfaces, the token is typically passed within a prescribed proximity of the target to achieve data communication between them.

Base unit 26 further includes a fingerprint scanner 34 and a speaker 36. As described in further detail below, to use the system a patient's finger is placed on scanner 34 when smart card 32 is inserted into reader/writer 30. A fingerprint scan determines whether the patient's fingerprint matches a profile that has been previously obtained and stored in a memory of card 32. The combination of card 32 and the fingerprint serve to verify the patient's identity. A unique biological characteristic of a person that can be measured and identified is known in the art as a biometric. Examples of well-known biometrics that can be electronically measured and identified include not only fingerprints but also iris or retinal patterns, voice prints, facial features, and genetic markers. Fingerprint scanner 34 and its operation are well-known in the art and therefore not described in further detail in this patent specification. Although fingerprint identification is included in the illustrated embodiment, in other embodiments other suitable biometric comparisons can be included, such as iris, retinal, voice print, facial feature or genome identification. In such other embodiments, in place of fingerprint scanner 34 a corresponding measurement or sampling device is included.

Computer 28 can be a conventional personal computer having a keyboard 38, monitor 40, mouse 42, floppy disk drive 44 and other hardware and software elements commonly included in personal computers. In a physician's office or hospital, it can be the computer system that is otherwise used apart from the invention for maintaining records, calendaring appointments, accounting, and other administrative tasks, or it can be a separate computer. In addition, computer 28 has network communication hardware and software, a modem or other hardware and software that enables data communication with remote servers. A suitable cable 46 connects computer 28 to a telephone exchange, a local-area network server, cable media network, or other intermediate system or systems (not shown) that are ultimately connected to Internet 10 (FIG. 1) in the conventional manner.

An alternative remote system is illustrated in FIG. 3. In contrast to the system illustrated in FIG. 2, in this system the base unit 48 integrates the above-described elements of the remote system into a single unit having wireless Internet communication capability. Base unit 48 thus includes a housing 50, keyboard 52, display 54, smart card reader/writer unit 56 and a fingerprint scanner 58, as well as an antenna 60. Housing 50 can resemble that of a conventional laptop computer, with the portion of housing 50 in which display 54 is retained foldable along a hinge against the remaining portion of housing 50. In other embodiments, base units can be miniaturized and resemble devices commonly referred to as personal digital assistants, cellular telephones, pagers or other conventional wireless devices and hybrids thereof. Except as specifically noted (e.g., wired as opposed to wireless communication), the remote system illustrated in FIG. 2 operates in essentially the same manner as that illustrated in FIG. 3. Therefore, the following description of the structure and operation of base unit 48 is generally applicable to other remote systems, the structure and operation of which may not be described in similar detail in this specification for purposes of clarity.

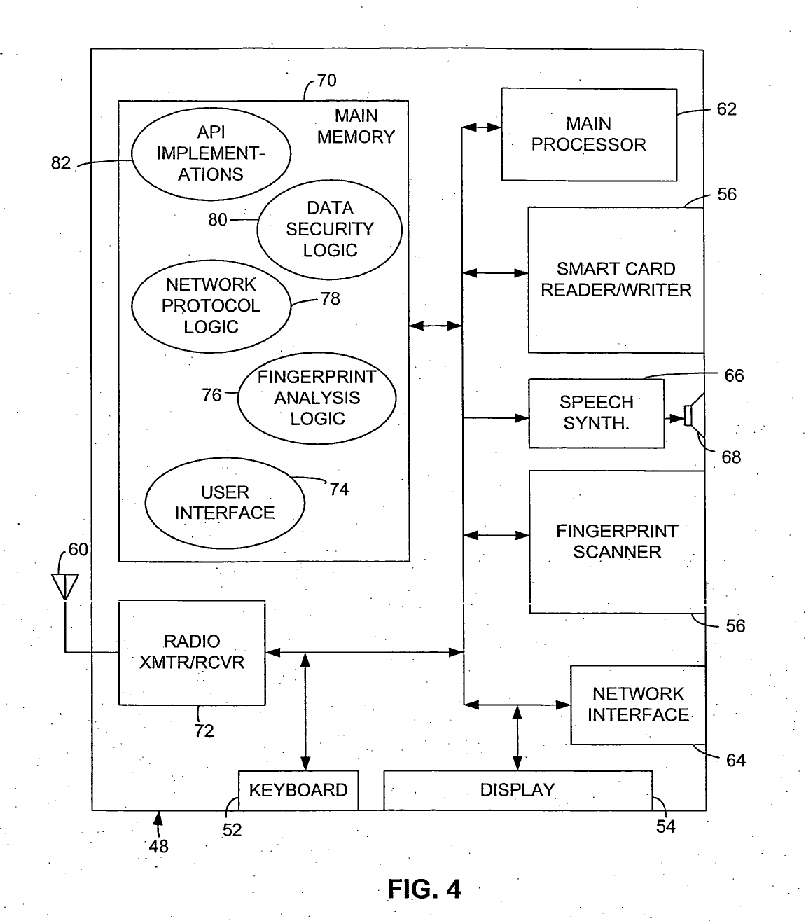

As illustrated in FIG. 4, base unit 48 includes, in addition to the elements described above, a main processor 62, a network interface 64, a speech synthesizer 66 and associated speaker 68, a main memory 70 and a radio transceiver 72. Processor 62 can include any suitable type or number of microprocessors, micro-controllers, central processing units or similar processors and any associated hardware, software and firmware. Network interface 64 represents the hardware and software necessary to enable base unit 48 to communicate with remote computers via a (wired) local-area network (LAN). Radio transceiver 72 similarly represents the hardware and software necessary to enable base unit 48 to communicate with remote computers, but via a wireless communication link rather than a wired link. As described above, base unit 48 can communicate via the Internet using either the wireless link or the wired LAN. In some circumstances, such as when base unit 48 is used in an ambulance or other mobile site, no wired connections are available, and network communication must be wireless.

Main memory 70 represents the random access memory in which most executable software and data are at least temporarily stored. Although not illustrated for purposes of clarity, base unit 48 can include data storage media of other types commonly included in computers, such as read-only memory, a floppy disk drive, hard disk drive, and removable disk drive (e.g., optical or magnetic media). Base unit 48 operates in accordance with its programming, which can be embodied in any suitable combination of software, firmware, hardware or other logic encoded in such memory and storage devices or retrieved remotely via a networked device. The programming of base unit 48 can be structured or organized in any suitable manner, but for illustrative purposes can include the following software modules: a user interface 74, fingerprint analysis logic 76, network protocol logic 78, data security logic 80 and application program interface (API) implementations 82. These modules operate collectively and in concert with database system 12 (FIG. 1) to effect the methods described below. Persons skilled in the art to which the invention pertains will appreciate that, like any software, processor 62 executes these modules by fetching instructions from memory 70, and that the modules, to the extent the programming is actually composed of such distinct modules, may not exist in their entirety or simultaneously in memory 70 at any given time. Rather, the modules are shown as they are (i.e., distinctly identifiable and residing simultaneously in memory 70 in their entireties for execution) for purposes of illustration only. As is common in the art, portions of the software can be loaded into memory 70 on an as-needed basis from a hard disk drive (not shown) or from a remote computer (not shown) via a network. Alternatively, some or all of the software can be encoded into read-only memory as firmware. Indeed, modules 74, 76, 78, 80 and 82 or similar software elements can be remotely located from one another in a distributed networked computing environment of the types that are becoming increasingly common. Note that the software as stored on or otherwise carried on a removable disk, network medium or other such computer-usable medium constitutes a “program product” that in part embodies the present invention. The invention is also embodied in the above-described remote systems as programmed with the relevant software. The invention is farther embodied in the computer-implemented methods or processes.

User interface 74 provides the functionality for interacting with the patient and healthcare professional. It controls what is displayed on display 54, received via keyboard 52, and spoken via speech synthesizer 66 and speaker 68. Information can be displayed in a graphical format using conventional windowing principles. Medical information can be displayed in a tabbed format that resembles a traditional patient medical chart. Fingerprint analysis logic 76 controls fingerprint scanner 34, captures the patient's fingerprint and compares it to corresponding information stored in smart card 32. Network protocol logic 76 controls data communication via wired network interface 64 and via the wireless network interface of transceiver 72. Network protocol logic 78 represents the software layer that encodes, decodes and formats data in accordance with communication protocols such as TCP/IP. Data security logic 80 operates in conjunction with fingerprint analysis logic 76 and smart card reader/writer unit 56 to permit a query to be transmitted via the appropriate network to database 12 if the patient's identity is verified. API implementations 82 can be accessed by devices connected to base unit 48 if it is desired to coordinate the functions of base unit 48 with a computer or other device. For example, if base unit 48 is connected to computer 28 (FIG. 2), software executing on computer 28 can make API calls to base unit 48 to control the communication of data, scanning of fingerprints and other functions. Such coordination may be desirable if practice management software executing on computer 28 requires data from base unit 48. Note that, although not shown for purposes of clarity, the same API functionality is included in base unit 26 (FIG. 2) to enable it to be controlled by computer 28 in the manner indicated.

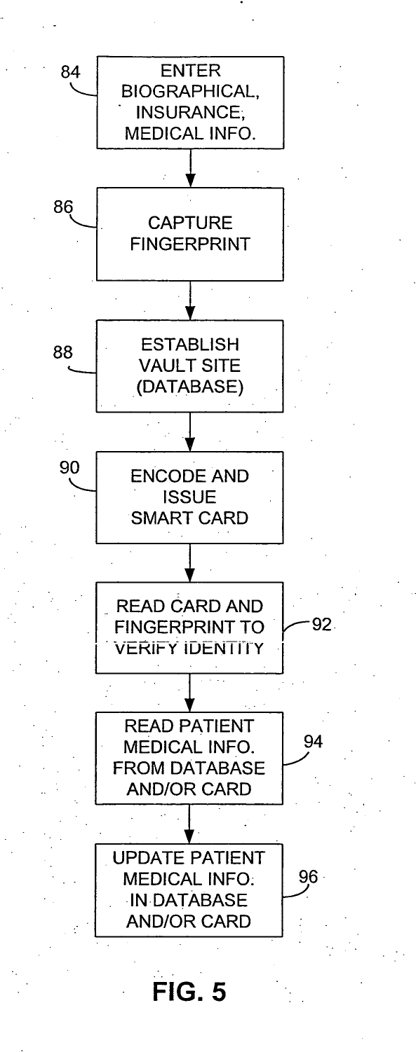

A method of operation in accordance with the present invention is illustrated by the flowchart of FIG. 5. In view of the following description of the method steps, persons skilled in the art to which the invention pertains will readily be capable of writing or otherwise providing suitable software for base unit 48 and other remote systems as well as for database system 12 (FIG. 1).

A person, including not only a patient but also an authorized healthcare provider, can enroll in a program or plan administered by a third party that contracts with the host of the database system 12 and controls the distribution and use of base units and smart cards. Steps 84, 86, 88 and 90 relate to the enrollment procedure. The program allows such persons and their healthcare providers to receive the benefits of using the present invention.

At step 84 a person (hereinafter referred to as the patient) performs the first step of the enrollment procedure at an enrollment center operated or licensed by or on behalf of the third party administrator. Alternatively, step 84 can be performed via the Internet (e.g., using patient system 22) by accessing a suitable website such as one maintained by the third party who maintains control of database system 12. Biographical information, insurance information and comprehensive medical information are entered into a suitable electronic form (not shown). The biographical information includes the patient's name, residence, identification number (e.g., in the U.S.A., a Social Security Number) and other personal information that identifies or describes the patient. The medical information includes lifesaving or vital medical information such as chronic illnesses or conditions, medications the patient is then taking, allergies, blood type, name and address of person to contact in an emergency, and other information that could be critically useful to emergency medical personnel. The medical information can also include other information of which the patient is aware, such as immunization history, past illnesses, surgical interventions, hospitalizations, family medical histories, and self-prescribed medical/pharmaceutical care. The healthcare provider completes a similar administrative enrollment process to participate in the chain of custody required to handle medical information as described herein.

At step 86 the patient's fingerprint is captured, either at the enrollment center or when the patient visits a healthcare provider equipped to capture fingerprints for the program. The devices and methods by which fingerprints are captured for automated biometric analysis is well-known and therefore not described in this patent specification. In essence, however, the method involves obtaining a digitized image of the fingerprint and extracting a set of characteristics known as minutiae that uniquely identify the fingerprint. At step 87 this fingerprint information is electrically transmitted to fingerprint information database 13. Database 13 stores the fingerprint information to allow the healthcare provider to re-issue a smart card 32 to a patient who has misplaced his originally issued smart card 32 or who otherwise is not in possession of it when he visits the provider. Database 13 has no direct connection to database 12 and is located at a site remote from that at which database 12 is located.

At step 88 a vault site for the patient is established in database system 20. The term “vault” refers to the security with which the patient's medical information is guarded against unauthorized access. Each patient enrolled in the program has a vault of one or more database records in which his or her medical information is stored. Nevertheless, the data can be organized in any suitable manner in accordance with well-known relational database principles. The vault is indexed by a unique alphanumeric identifier; no two patients' vaults have the same identifier. The identifier can be randomly generated or generated using a hash algorithm such that it does not reveal the patient's identity. The system preserves a patient's privacy by not storing the biographical information or other identifying information in the vault. Rather, only the medical information itself is stored in the vault. During this step of the enrollment procedure, some of the medical information entered by the patient can be stored in the vault. If available, historical medical information obtained from physicians or others who have provided medical care for the patient can also be stored in the vault at this time.

At step 90 smart card 32 is created and issued to the patient. The fingerprint or other biometric information as well as insurance information and vital medical information that the patient entered are encrypted and stored in the card memory. The patient is given smart card 32. When the patient visits a healthcare provider or other healthcare professional to obtain services the patient brings smart card 32 with him. Note that an appropriate subset of enrollment steps 84-90 can be performed at the provider's site if, as mentioned above, a patient is no longer in possession of his smart card 32 when he visits the provider. The fingerprint information can be retrieved from database 13 and stored in the card memory. If a provider reissues a smart card 32 to a patient under such circumstances, the previously issued smart card 32 is rendered inoperative.

Steps 92, 94 and 96 occur when the patient visits a healthcare professional. In an exemplary scenario in which the patient visits a physician's office, at step 92 the patient inserts smart card 32 into reader/writer unit 30 (FIG. 2) and places his finger on scanner 34. Through speaker 36 base unit 26 may issue a voice announcement acknowledging the patient by name and requesting that he or she be seated to await the physician. Base unit 26 scans the patient's fingerprint, reads and decrypts the corresponding fingerprint information stored in smart card 32 and, if they match, permits encrypted data to thereafter be transferred between base unit 26 and database system 12 via the Internet at step 94. It also permits the biographical, vital medical, insurance and other information retrieved from card 32 to be displayed for the physician on display 40 of computer 28 at step 94. A physician can, for example, retrieve a patient's medical information from database 12 to familiarize himself with the patient's history. As noted above, the information is displayed in conventional medical chart format. Following diagnosis or treatment, at step 96 the physician can enter his diagnosis, any treatment the patient received, medications the physician gave to the patient or prescribed for the patient, pertinent test results, impressions, and any other relevant information of the type conventionally maintained in medical records. Standard diagnostic codes and procedure codes (e.g., those known respectively as ICD-9 and CPT codes) can be entered.

When the patient is ready to leave the office, he or she can again identify himself using smart card 32 and fingerprint scan, at which time any appropriate information, such as a drug prescription created by the physician, is transferred to card 32, as indicated by step 96. At that time computer 28 also causes base unit 26 to encrypt and transmit the entered information to database system 12 for storage in the patient's vault. Note that base unit 26 accesses the patient's records using the index number stored in card 32. The patient's insurance information read from card 32 can be imported into the physician's billing software on computer 28 for billing purposes. Lastly, base unit 26 may issue a voice announcement thanking the patient and advising the patient that his records have been updated.

The system also facilitates physician access to related medical information not specific to the patient. For example, if a diagnostic code is displayed on a patient's chart, the physician can select it using mouse 42 or similar pointing device. In response to the selection, base unit 26 can retrieve from a medical content provider further information explaining the disease or other condition related to the code.

The system permits what is commonly known as delayed coding. That is, database system 12 can accept for storage information received from base unit 26 during a predetermined time window, beginning when base unit 26 first verifies the patient's identity upon arrival at the facility and ending a few days after the patient leaves the facility (e.g., after the patient is discharged from a hospital (having, e.g., system 16 shown in FIG. 1)). The number of days can be preselected or predetermined by appropriately programming the system. Base unit 26 can implicitly identify the facility in which it is located by transmitting its serial number or other identifying information to database system 12. Base unit 26 can write information to database system 12 during this delayed coding window, but can only read information from database system 12 during the time the patient is actually at the facility. Once the patient has checked out (i.e., base unit 26 has verified the patient's identity at the conclusion of the visit), that base unit 26 can no longer read information from database 12 until the patient returns to the facility for further care. A few days later at the end of the delayed coding window, database system 12 can no longer accept information for storage from that base unit 26 until the patient returns to the facility for further care. Note that the patient can interact with other base units 26, i.e., those located at facilities other than that which the patient previously visited, independently of and without regard to the delayed coding window or other status of base unit 26 at the facility previously visited. Card 32 is rendered void if the coding indicating death is entered to not allow further use of card 32 in a fraudulent manner.

Card 32 can act as an electronic prescription pad. The patient can take card 32 to a participating pharmacy (i.e., a pharmacy having, for example, system 20 shown in FIG. 1) to have a prescription filled. Step 94 is performed at a pharmacy having the same or similar base unit 26. The patient identifies himself using smart card 32 and fingerprint scan. If the patient's identity is verified, base unit 26 reads the prescription from card 32 and causes it to be displayed for the pharmacist. After the pharmacist fills the prescription, he or she can again identify himself using smart card 32 and fingerprint scan, at which time an indication is stored in card 32 that the prescription has been filled, as indicated by step 96. The next time the patient visits the physician, this indication can be read from the card and displayed for the physician. The physician will be alerted by the absence of the indication if the patient has not filled the prescription. The indication can be graphically represented by, for example, a checkmark in a box on the patient's chart adjacent the prescription.

In another exemplary scenario in which the patient is being transported by ambulance, at step 92 emergency medical personnel can assist the patient by presenting smart card 32 (which may, for example be found in an unconscious patient's wallet) and the patient's finger to base unit 48 (FIG. 3). Base unit 48 is useful in mobile environments such as ambulances because its communication link with database system 12 is wireless. At step 94 personnel can obtain the patient's medical records from database 12 and, at step 96, update database system 12 to reflect the patient's condition and any treatment they provided. The integral display 54 and keyboard 52 enable base unit 48 to function independently of another local computer. In addition, even if the wireless Internet link is inoperable, e.g., malfunctioning, such personnel can access the potentially lifesaving medical information stored on card 32.

It is important to note that a patient's biographical or other identifying information and the patient's medical information are not combined at any site accessible to unauthorized parties, thereby preserving patient confidentiality. Nevertheless, researchers, government agencies and others (e.g., research system 24 in FIG. 1) who may benefit from analysis of aggregate medical data can retrieve data from database 12 or obtain reports generated on their behalf using data retrieved from database system 12. Confidentiality is preserved because the information identifying the patients is stored only on their smart cards and not available to such outside parties. As noted above, patients (e.g., patient system 22 in FIG. 1) can access their own medical records through a suitable, secure website interface. By retaining control of their smart cards 32, and the inherent control over their own fingerprints, patients are made to feel that they themselves have control over the dissemination of their medical information.

The above described embodiments are given as illustrative examples only. It will be readily appreciated that many deviations may be made from the specific embodiments disclosed in this specification without departing from the invention. Accordingly, the scope of the invention is to be determined by the claims below rather than being limited to the specifically described embodiments above.

1. A system for managing a person's healthcare information, comprising:
a database system for healthcare information relating to a plurality of patients, database entries of said healthcare information for each patient identified only by an identifier code and not identified by name or other biographical information, said database system having an interface to a wide-area computer network;
a plurality of patient tokens, each token associable with an individual patient and portable by said individual patient and having memory in which are storable biographical information identifying said individual patient and an identifier code corresponding to said identifier code in said database system relating to a corresponding entry for said individual patient in said database system; and
a plurality of base units remotely located from said database system, each base unit associable with a healthcare provider, said base unit having a wide-area network interface through which information can be communicated with said database system, having a token interface circuit with which any one of said tokens can communicate when placed in proximity with a portion of said token interface circuit, and having a biometric processor with a sensor, said base unit permitting said biographical information identifying a patient to be read from said memory of a token only if said biometric processor verifies said patient's identity by determining said patient has a biometric predetermined to be uniquely identifiable with said patient and not identifiable with any other patients, said base unit permitting healthcare information entries for said patient to be read from said database system via a wide-area network only if said biometric processor verifies said patient's identity by determining said patient has a biometric predetermined to be uniquely identifiable with said patient and not identifiable with any other patients.

2. The system claimed in claim 1, wherein information is stored in said memory of said token in encrypted format.

3. The system claimed in claim 1, wherein said biometric processor is a fingerprint analyzer, and its sensor is a fingerprint scanner.

4. (canceled)

5. The system claimed in claim 1, wherein said token is a smart card having a processor.

6. (canceled)

7. The system claimed in claim 1, wherein
said token interface circuit can communicate information bi-directionally with a token; and
and said base unit permits said healthcare information for said patient to be written to said database system only if said biometric processor verifies a patient's identity by determining said patient has a biometric predetermined to be uniquely identifiable with said patient and not identifiable with any other patients.

8. The system claimed in claim 1, wherein said base unit permits healthcare information to be read from and written to said database system within a first predetermined time interval after said biometric processor verifies said patient's identity and thereafter prevents healthcare information from being read from and written to said database system until said biometric processor again verifies said patient's identity.

9. The system claimed in claim 8, wherein said database system has a write-only mode in which said database system permits healthcare information for a patient to be written to it during a second predetermined time interval following said first predetermined time interval and does not permit healthcare information to be read from said database system during said second predetermined time interval.

10-12. (canceled)

13. The system claimed in claim 1, wherein said database system permits information to be read from said database system by a remote computer via a wide-area network in response to a secure personal identification number received from said remote computer.

14. The system claimed in claim 1, wherein:
vital medical information for said individual patient is storable in said memory of each said token; and
said base unit permits said vital medical information to be read from said token only if said biometric processor verifies said patient's identity.

15. (canceled)

16. The system claimed in claim 1, wherein:
insurance information for said individual patient is storable in said memory of each said token; and
said base unit permits said insurance information to be read from said token only if said biometric processor verifies said patient's identity.

17. The system claimed in claim 1, wherein:
prescription information for said individual patient is storable in said memory of each said token; and
said base unit permits said prescription information to be read from said token only if said biometric processor verifies said patient's identity.

18. A system for managing healthcare patient information storable in a database system and accessible using tokens associated with patients, comprising:
a base unit remotely located from said database system, said base unit having a wide-area network interface through which information can be bi-directionally communicated with said database system, having a token interface circuit with which a token can communicate when placed in proximity with a portion of said token interface circuit, having a computer interface through which information can be communicated between said base unit and a computer operated by a healthcare professional, and having a biometric processor with a sensor, said base unit permitting information to be bi-directionally communicated with said database system via a wide-area network only if said biometric processor verifies said patient's identity by determining said patient has a biometric predetermined to be uniquely identifiable with said patient and not identifiable with any other patients; and
a computer program product for said computer operated by said healthcare professional, said computer program product comprising a data storage medium on which is recorded in computer-readable format a means for causing information read from said database to be displayed on said computer.

19. (canceled)

20. The system claimed in claim 18, wherein said computer program product further has recorded thereon in computer-readable format:
means for entering diagnosis information by said healthcare professional into said computer and causing said diagnosis information to be written to said database system, wherein said healthcare information stored in said database system includes said diagnosis information; and
means for entering treatment information by said healthcare professional into said computer and causing said treatment information to be written to said database system, wherein said healthcare information stored in said database system includes said treatment information.

21-23. (canceled)

24. The system claimed in claim 18, wherein said computer program product further has recorded thereon in computer-readable format means for entering prescription information by a physician into said computer and causing said prescription information to be written to a memory of said token.

25. (canceled)

26. The system claimed in claim 18, wherein said computer program product further has recorded thereon in computer-readable format:
means for reading prescription information from a memory of said token and causing said prescription information to be displayed on said computer for review by a pharmacist; and
means for entering pharmacy information by said pharmacist indicating whether a prescription defined by said prescription information has been filled and causing said pharmacy information to be written to a memory of said token.

27. A method for managing healthcare patient information, comprising:
enrolling a patient by capturing a biometric uniquely identifiable with said patient and not identifiable with any other patients, storing healthcare information in a database system, and issuing said patient a token having a memory in which is stored biographical information identifying said patient and an identifier code, database entries for said patient identified only by an identifier code corresponding to said identifier code stored in said memory and not identified by patient name or other biographical information;
interfacing said token issued to said patient with a base unit issued to a healthcare professional;
said base unit obtaining a biometric measurement from said patient;
said base unit verifying said patient's identity by determining whether said measurement has said biometric uniquely identifiable with said patient; and
permitting healthcare information entries to be read from said database system only if said patient's identity is verified; and
permitting said biographical information to be read from said memory of said token only if said patient's identity is verified.

28. The method claimed in claim 27, wherein said step of capturing a biometric comprises storing captured biometric information in said memory of said token.

29-30. (canceled)

31. The method claimed in claim 27, further comprising:
displaying said healthcare information on a display of a computer coupled to said base unit; and
permitting healthcare information for said patient to be written to said database system from said computer only if said patient's identity is verified.

32-37. (canceled)

38. The method claimed in claim 27, further comprising:
reading said healthcare information from said database if said patient's identity is verified and displaying said healthcare information on a display of a computer coupled to said base unit and operated by a physician; and
said physician entering prescription information into said computer and if said patient's identity is verified causing said prescription information to be written to said memory of said token.

39. The method claimed in claim 38, further comprising:
reading said prescription information from said memory of said token if said patient's identity is verified and displaying said prescription information on a display of a computer coupled to said base unit and operated by a pharmacist; and
said pharmacist entering into said computer an indication whether said prescription has been filled and if said patient's identity is verified causing said indication to be written to said memory of said token.

40-42. (canceled)
